(19) United States
(12) Patent Application Publication
(10) Pub. No.: US 2005/0238311 A1
(43) Pub. Date: Oct. 27, 2005

(54) Support fixture and method for supporting subscriber specific fiber optic drop wire

(76) Inventor: Joseph H. Forrester, Buford, GA (US)

Correspondence Address: SHOEMAKER AND MATTARE, LTD, 10 POST OFFICE ROAD - SUITE 110, SILVER SPRING, MD, 20910, US

(21) Appl. No.: 10/829,458

(22) Filed: Apr. 22, 2004

(51) Int. Cl. G02B 6/00

(52) U.S. Cl. 385/136

(57) ABSTRACT

Fiber optic drop wires extending from a cable closure supported along a fiber optic cable are supported by small horseshoe-shaped bend radius protectors which not only prevent overbending of the drop wires, but also enable one to store excess drop wire length on the bend radius protectors. The free end of the drop wire is clamped to a utility pole.

### BACKGROUND OF THE INVENTION

This invention relates to a support fixture and method for supporting subscriber specific fiber optic drop wire.

The present invention relates generally to a method of aerially supporting lengths of fiber optic drop wire for subscriber applications, and more specifically, to an apparatus for supporting multiple lengths of fiber optic drop wire while maintaining a specified minimum bend radius.

Means for aerially supporting surplus lengths of fiber optic cable and apparatus designed to maintain a minimum specified bend radius for such cable are well known. However, prior devices specifically intended for fiber optic cable are not necessarily applicable to fiber optic drop wire, which has only recently been put into use.

While some of the of the requirements for installation of fiber optic drop wire are similar to that of fiber optic cable, some distinctly different requirements apply to fiber optic drop wire. Like fiber optical cable, fiber optic drop wire must be provided with means for supporting a surplus length of drop wire and protecting it against over-bending where the direction of the run must change. In the case of fiber optic cable, the surplus length of cable is contiguous with the main run, serving to provide for a surplus length alone. However, in the case of fiber optic drop wire, a surplus length of drop wire must be provided in conjunction with a separate independent run that is directed away from the main run of cable at some point in order to terminate at the subscriber location. The fiber optic drop wire originates from a closure or terminal located on the main cable run where, most often, multiple drop wires will also originate to be routed to various different subscriber locations. Therefore, as opposed to similar apparatus and systems designed specifically for fiber optic cable, those for fiber optic drop wire must be capable of supporting numerous runs of drop wires on one fixture in a manner that is organized and provides an unobtrusive application while protecting against violating the minimum bend radius requirement of any given drop wire. Further, the system must provide for a means of neatly directing multiple runs in multiple directions.

Unlike support systems for fiber optic cable, where support fixture attachments are primarily associated with the main cable run, any apparatus for supporting fiber optic drop wires must be versatile and adaptable in a manner that will allow attachments to be made to adjacent runs as well as the run from which the drop originates, or to other locations. This provides flexibility in routing and also prevents the overload of any particular run.

Inasmuch as fiber optic drop wire is dimensionally different from the larger fiber optic cable, the dimensional requirements for support fixtures will differ from those designed for fiber optic cable as well. For the same reason, the system of storing surplus lengths of fiber optic drop wires with respect to lengths and occupied space will differ from that of fiber optic cable.

Additionally, because the connection of fiber optic drop wires to the main fiber optic cable can now be accomplished at the actual terminal or closure without having to remove the surplus length of the run, the requirements regarding length of surplus material for fiber optic drop wire will differ from those of the fiber optic cable, the length of surplus for the drop being only, as a rule, the amount required to accommodate a pole relocation or some other rerouting requirement. However, should the drop originate from a terminal or closure located within the surplus loop of the main fiber optic cable run, additional surplus drop length may be required, presenting additional need for versatility with respect to the apparatus' ability to accommodate multiple wraps as well as its ability to be attached at various locations.

The terms “fiber optic cable” and “fiber optic drop wire” as used in this application denote elements of greatly differing size. Fiber optic “cable” has a minimum of eighteen fibers, whereas fiber optic “drop wire” usually has only one or two fibers. Consequently, they are of substantially different diameters, and have correspondingly different minimum bend radii. Fiber optic cable bend radius protectors available today have bend diameters between ten and thirty inches (five to fifteen inch bend radius), whereas the fiber optic drop wire bend radius protectors have bend diameters not greater than six inches (three inch bend radius). Another important difference is that fiber optic drop wire is always self-supporting: it contains tensile elements like Kevlar strands, and thus does not need an external support such as a messenger cable. Fiber optic cable, on the other hand, may or may not have tensile elements, and may be supported by a messenger, as shown in the drawings. An example of a fiber optic drop wire is the “Mini DP Flat Drop Cable” made by Fitel USA Corp. It comprises two dielectric rods, one on either side of an extruded polymer tube in which two optical fibers are embedded. The rods and tube are covered by a DHPE jacket. It should be understood that this example is only for the purpose of illustration, and is not to be interpreted as a limitation to the claims that follow.

The present invention provides for apparatus and methods of application that are directed to the unique requirements of the installation of subscriber specific fiber optic drop wire.

According to the invention, a horseshoe-shaped device is used exclusively for the storage of and bend radius protection of “drop” wires (individual self-supporting that span from the pole to the house or premise) after leaving a multi port splice closure. These drop cables are very small self-supported cables with very low fiber counts as opposed to high fiber count transmission lines and are used almost exclusively for fiber to the house (FTTH) or fiber to the premise (FTTP) applications that are just now being developed.

Currently, fiber is reversed back to the pole from the splice closure and is “coiled” at the pole to provide a reserve length of fiber should the pole have to be moved or replaced. The reverse point of the fiber optic drop cables does not have the bend radius protected and the coils of the pole are time consuming and very unsightly since each splice closure can have as many as 16 separate drop cables exiting it. These units are designed for multiple wraps of the ADSS drop cables. The drop cable is very small and only needs a very small loop diameter (as compared to standard optical fiber cable).

### SUMMARY OF THE INVENTION

An object of the invention is to simplify the routing of drop cables from a cable closure. Another object is to permit an installer to store excess drop cable in loops supported by bend radius protectors.

These and other objects are attained by a support fixture and method for supporting subscriber specific fiber optic drop wire

### BRIEF DESCRIPTION OF THE DRAWINGS

In the accompanying drawing:

FIG. 1 is an isometric view of a support fixture and method for supporting subscriber specific fiber optic drop wire embodying the invention;

FIG. 2 is an isometric view of an alternative application;

FIG. 3 is a schematic view, from above, showing the cable routing of the arrangement illustrated in FIG. 1; and

FIG. 4 is a schematic view, from above, showing the cable routing of the arrangement illustrated in FIG. 2.

### DESCRIPTION OF THE PREFERRED EMBODIMENT

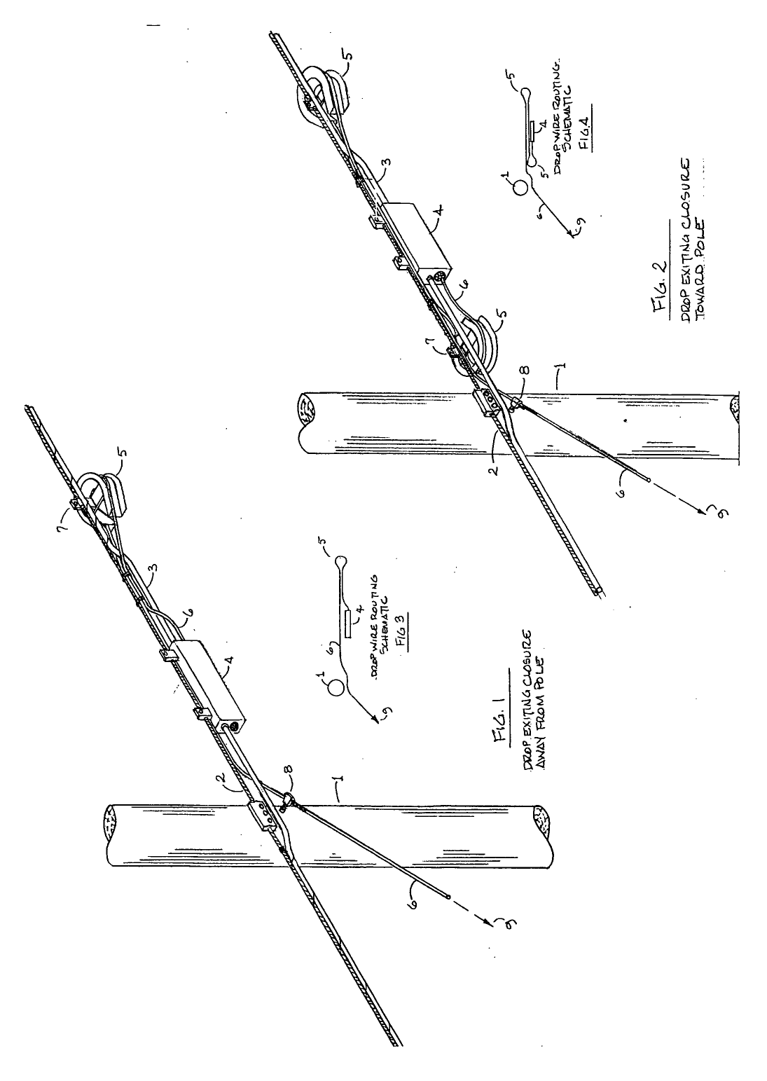

A fixture embodying the invention, shown in FIG. 1, includes a horseshoe-shaped bend radius protector 5 having two flanges defining an external channel for containing plural fiber optic drop wires. The protector 5 is suspended by a bracket 7 from a steel messenger cable 2 which is secured to a pole 1 by a clamp. A fiber optic cable 3 running along the messenger is secured to the messenger cable by wrapping. The cable closure 4 contains optical connectors which pass signal from the main cable to one or more drop wires 6. In most cases, three to sixteen drop wires extend from each cable closure; however, only one is shown in the drawing for the sake of clarity. The external channel of each bend radius protector is large enough to support from three to sixteen drop wires.

The cable closure has two ends: one near the pole and one further away. In the arrangement of FIG. 1, a drop wire extends from the further end in a direction away from the pole. It is tied to the messenger cable, and then proceeds around the bend radius protector 5 and back along the messenger, past the closure, and through a wedge-type drop wire clamp 8 secured to the pole. The clamp applies pressure to the tensile strands of the drop wire, which are larger than the fibers between them and therefore protect the fibers from damage.

In the alternative arrangement of FIG. 2, two bend radius protectors are installed, one on either side of the cable closure. The drop wire extending from the near end of the closure is passed around the proximal protector, then run along the messenger, around the distal protector, and back through the drop wire clamp 8. With this arrangement, more than one loop of each drop wire can be run around the protectors, if desired, to provide flexibility in case the drop wire should have to be rerouted later.

In practice, many drop wires will extend from a single closure, en route to different homes or locations. For this reason, each bend radius protector should have a flange depth and a distance between flanges sufficient to accommodate up to sixteen drop wires at once.

While the arrangements shown in the drawings have the bend radius protectors and the cable connection closures suspended from the cable messenger, other arrangements are possible. For example, the bend radius protector (or one bend radius protector, where more than one are used) may be attached directly to a pole, or may be suspended directly from the optical cable, where self-supporting cable is used.

Since the invention is subject to modifications and variations, it is intended that the foregoing description and the accompanying drawings shall be interpreted as only illustrative of the invention defined by the following claims.

1. A fixture for supporting subscriber specific fiber optic drop wire extending from a cable closure containing a connection between the fiber optic drop wire and a fiber optic cable supported by utility poles, said fixture comprising
a bend radius protector having a grooved periphery of a radius at least as great as the minimum drop wire bend radius but less than the fiber optic cable bend radius, and
means for suspending the bend radius protector from the cable, a cable support messenger or a pole.

2. The fixture of claim 1, wherein said radius is not greater than three inches.

3. A fixture for supporting subscriber specific fiber optic drop wire extending from a cable closure containing a connection between the fiber optic drop wire and a fiber optic cable supported by utility poles, said fixture comprising
a pair of bend radius protectors, each having grooved periphery of a radius at least as great as the minimum drop wire bend radius but less than the fiber optic cable bend radius, and
means for suspending each bend radius protector from the cable.

4. The fixture of claim 3, wherein said radius is not greater than three inches.

5. The fixture of claim 3, wherein the drop wire extends from the cable closure, around one of the bend radius protectors, thence around the other of said bend radius protectors, thence through a clamp secured to one of said poles.

6. A method for supporting subscriber specific fiber optic drop wire extending from a cable closure containing a connection between the fiber optic drop wire and a fiber optic cable supported by utility poles, said method comprising steps of
suspending the cable closure from the fiber optic cable in the vicinity of a selected pole,
suspending a bend radius protector having a grooved periphery of a radius at least as great as the minimum drop wire bend radius, from the fiber optic cable at a point on the cable further from the selected pole than the cable closure,
passing the fiber optic drop wire around the periphery of the bend radius protector and back towards the selected pole, and then
clamping the fiber optic drop wire to the selected pole.

7. A method for supporting subscriber specific fiber optic drop wire extending from a cable closure containing a connection between the fiber optic drop wire and a fiber optic cable supported by utility poles, said method comprising steps of
suspending the cable closure from the fiber optic cable in the vicinity of a selected pole,
suspending from the fiber optic cable a pair of bend radius protectors, each having a grooved periphery of a radius at least as great as the minimum drop wire bend radius, the bend radius protectors straddling the cable closure so that one bend radius protector is closer to the selected pole that the cable closure, and one is further away,
passing the fiber optic drop wire from the cable closure around the periphery of the bend radius protector closer to the pole, then around the periphery of the bend radius protector further away, then back toward the selected pole, and
clamping the fiber optic drop wire to the selected pole.
